(19) United States
(12) Patent Application Publication
(10) Pub. No.: US 2009/0206613 A1
(43) Pub. Date: Aug. 20, 2009

(54) Latch module

(75) Inventor: James Hawang, Taipei City (TW)

Correspondence Address: BACON & THOMAS, PLLC, 625 SLATERS LANE, FOURTH FLOOR, ALEXANDRIA, VA, 22314-1176, US

(73) Assignee: Kenmark Industrial Co., Ltd.

(21) Appl. No.: 12/071,073

(22) Filed: Feb. 15, 2008

(51) Int. Cl. E05C 3/12

(52) U.S. Cl. 292/57

(57) ABSTRACT

The present invention discloses a latch module installed at a joint position between two plates for connecting and assembling the two plates. The latch module includes a fixing element embedded into a joint surface of a first plate, a positioning base embedded into a second plate, and a turning element installed in the positioning base and being turnable accordingly, and exposed from a joint surface of the second plate for engaging the joint surface of the first plate and the joint surface of the second plate, such that the connection between the first plate and the second plate can be secured. If it is necessary to dismount the latch module, the turning element is turned in an opposite direction to release the latch between the positioning portion and the fixing element.

### BACKGROUND OF THE INVENTION

1. Field of the Invention

The present invention relates to a connecting means for connecting a plurality of plates, and more particularly to a latch module that provides an effective positioning effect and a convenient installation or removal.

2. Description of the Related Art

As Do-it-yourself (DIY) becomes increasingly popular, many large chain house maintenance stores are established, and many manufacturers constantly introduce various different consumer DIY products to the market and provide users to assemble furniture products such as bookshelves, combinational cabinets, and CD racks, etc.

Since DIY products require no professional assemblers to go to a customer's house to assemble the products, therefore the DIY products generally come with a lower price and become increasingly more popular, and many DIY furniture use nails for fixing the assembly or screws for securing the products.

Unlike professional assemblers, consumers may need to remove an incorrectly installed part and reinstall the part during the assembling process of DIY furniture. If the DIY furniture is assembled and fixed by nails, then it will be very difficult to reinstall the parts, or any reinstalling may damage the product easily. If the DIY furniture is assembled and fixed by screws, then it is necessary to reinstall the parts by repeatedly loosening and securing the screws, and thus the thread of the screw will be damaged. As a result, the DIY product incurs a higher cost and a less convenient assembling process.

In addition, many other DIY furniture products sold in the market also provide a latch module for consumers to assemble the furniture by a simple snap-in action. To make it easy to securely assemble DIY furniture, most of the traditional latch devices come with a structural design featuring an easy installation but a difficult dismount, and thus traditional latch devices cannot overcome the aforementioned shortcomings of uneasy to remove the wrong installed parts and easy to damage the product.

Therefore, the inventor of the present invention developed a latch module that can be embedded onto the product easily and provides a simple and convenient installation or dismount.

### SUMMARY OF THE INVENTION

It is a primary objective of the present invention to overcome the foregoing shortcomings of the prior art by providing a latch module, so that consumers can assemble or remove two plates of a DIY product easily to achieve the effect of a convenient application.

To achieve the foregoing objective, the present invention provides a latch module comprising: a fixing element embedded into a joint surface of the first plate, a positioning base embedded into a vertical plane of a lateral edge on a joint surface of the second plate; a turning element pivotally coupled to an axle hole of the positioning base for a shifted turning, a positioning portion disposed on a lateral end of the turning element and exposed from a joint surface of the second plate for engaging the joint surfaces of the first plate and the second plate, so that after the positioning portion is embedded into the fixing element, the turning element is turned to latch the positioning portion into the fixing element, and secure the connection between the first plate and the second plate. If it is necessary to remove the latch module, the turning element is turned in an opposite direction to release the latch of the positioning portion with the fixing element.

In an embodiment, the fixing element includes a containing space, and the top of the containing space has a bar-shaped opening, and the top of the bar-shaped opening is exposed from the joint surface of the first plate.

The positioning base includes a movable groove disposed at the center, an inwardly tapered longitudinal cut groove disposed proximate to the sidewall at the joint surface of the second plate, and a transverse axle hole disposed at the bottom of the positioning base and having a diameter greater than the width of the cut groove, and an end of the transverse axle hole is situated at the bottom of the cut groove, passed through the sidewall of the positioning base, and exposed from the joint surface of the second plate.

The turning element includes a rod with a diameter corresponding to the axle hole, and an end of the rod includes a positioning portion corresponding to the opening, and the top of the rod includes a turning plate corresponding to the movable groove of the positioning base, and the thickness of the turning plate is slightly greater than or equal to the minimum width of the cut groove, such that the rod can be aligned with the axle hole and the turning plate can be aligned with the cut groove to allow the turning plate to be passed through the cut groove and embedded into the movable groove in order to connect the turning element with the positioning base, and the turning plate can be turned with respect to the positioning base. After the turning element is connected with the positioning base, the positioning portion on a lateral end is exposed from the joint surface of the second plate.

After the first plate is engaged with the second plate, the positioning portion of the turning element is embedded into the opening of the fixing element, and the turning plate drives the rod to turn the positioning portion, so that the positioning portion is turned with respect to the opening and latched into the containing space of the fixing element to secure the connection between the first plate and the second plate.

In an embodiment, the fixing element, the positioning base and the turning element are made of a plastic material and integrated formed, and thus having the advantage of a low cost. Further, the positioning base includes a latch portion disposed on an external side of the positioning base and comprised of a plurality of serrations, such that after the positioning base is embedded into the plates, a secured positioning effect can be achieved.

Unlike the prior art, the invention simply needs to engage the joint surfaces of the first plate and the second plate for assembling the two plates, and allowing the turning element to turn for a quick assembling. If it is necessary to remove the latch module, the turning element is turned in an opposite direction to release the latch between the positioning portion and the fixing element. The invention has the advantage of easy installations and removals, and does not constitute any damage to the plates during the reinstallation or dismounting process, so as to provide a convenient application.

### BRIEF DESCRIPTION OF THE DRAWINGS

FIG. 1 is a perspective exploded view of an assembly of the present invention;

FIG. 2 is an exploded view of the present invention;

FIG. 3 is a schematic view of a positioning base before being assembled to a turning element in accordance with the present invention;

FIG. 4 is a schematic view of a positioning base while being assembled to a turning element in accordance with the present invention;

FIG. 5 is a schematic view of a positioning base after being assembled to a turning element in accordance with the present invention;

FIG. 6 is a sectional view of assembling a positioning base with a second plate in accordance with the present invention;

FIG. 7 is schematic view of related position before first and second plates are assembled in accordance with the present invention;

FIG. 8 is schematic view of assembling first and second plates in accordance with the present invention; and

FIG. 9 is schematic view of an assembly after first and second plates are assembled in accordance with the present invention.

### DETAILED DESCRIPTION OF THE PREFERRED EMBODIMENTS

The objective, technical measures and performance of the present invention will become apparent in the detailed description of the preferred embodiments with reference to the accompanying drawings as follows:

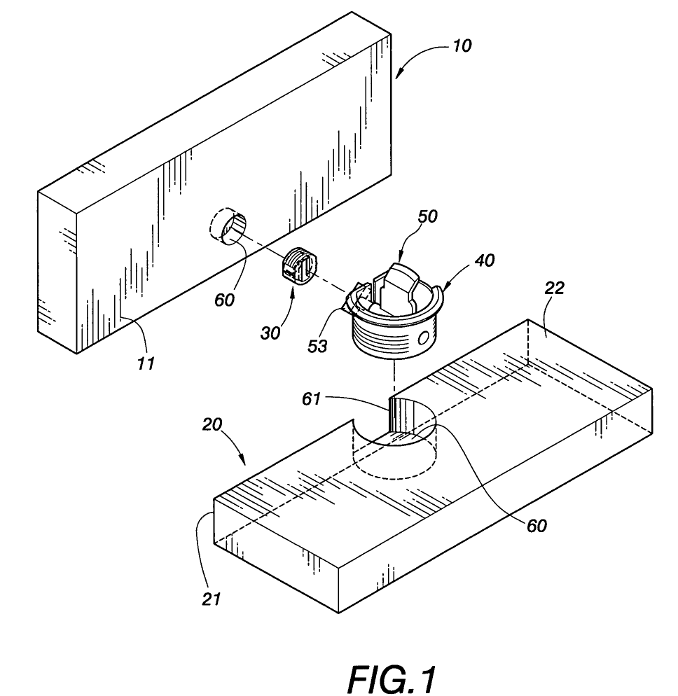

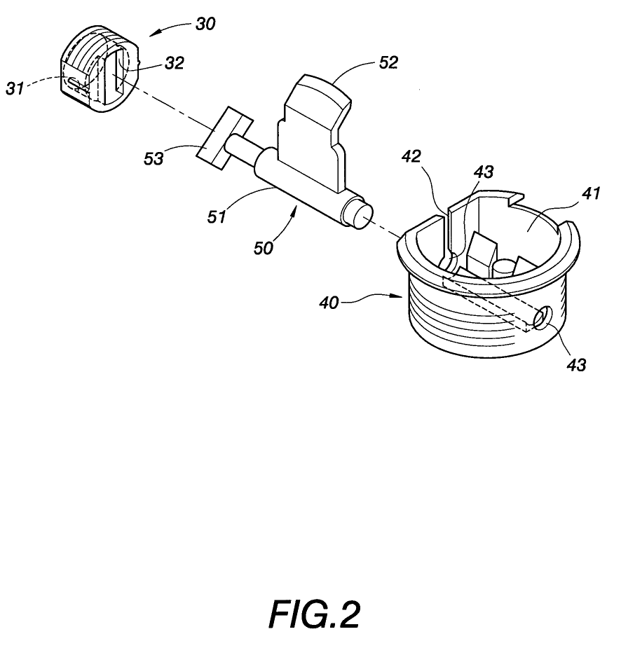

Referring to FIGS. 1 and 2 for a latch module of the present invention, the latch module is installed at a joint position of a first plate 10 and a second plate 20. The latch module comprises a fixing element 30 embedded into a joint surface 11 of the first plate 10, a positioning base 40 on a vertical plane 22 embedded into a lateral edge on a joint surface 21 of the second plate 20, and a turning element 50 installed onto the positioning base 40.

During use, the joint surface 11 of the first plate 10 and the vertical plane 22 of the second plate 20 have assembling holes 60 corresponding to the fixing element 30 and the positioning base 40 respectively provided for embedding and fixing the fixing element 30 with the positioning base 40. In addition, the lateral side of the assembling hole 60 on the vertical plane 22 of the second plate 20 is proximate to the joint surface 21, and has an open groove 61 situated on the joint surface 21 of the second plate 20, such that when the positioning base 40 is embedded into the assembling hole 60 on the vertical plane 22 of the second plate 20, the lateral side is exposed from the joint surface 21 of the second plate 20.

The fixing element 30 includes a containing space 31 therein, and the top of the containing space 31 has an opening 32, and the top of the opening 32 is exposed from the joint surface 11 of the first plate 10. In the figure, the opening 32 is in a bar shape.

The positioning base 40 embedded into the vertical plane 22 of the second plate 20 comprises a movable groove 41 disposed at the middle, an inwardly tapered longitudinal cut groove 42 disposed on a sidewall of the joint surface 21 of the second plate 20, and a transverse axle hole 43 disposed at the bottom and having a diameter greater than the width of the cut groove 42, and an end of the transverse axle hole 43 is connected to the bottom of the cut groove 42. When the positioning base 40 is embedded into the assembling hole 60 on the vertical plane 22 of the second plate 20, a lateral side of the cut groove 42 and the axle hole 43 of the positioning base 40 is exposed from the lateral edge of the joint surface 21 of the second plate 20.

The turning element 50 comprises a rod 51 having a diameter corresponding to the axle hole 43, and the turning element 50 can be embedded into the axle hole 43 for connecting the positioning base 40, and rotated with respect to the positioning base 40. The rod 51 includes a turning plate 52 corresponding to the movable groove 41 of the positioning base 40, and a lateral end of the rod 51 is protruded from the axle hole 43 of the positioning base 40 and the joint surface 21 of the second plate 20, and a positioning portion 53 is aligned with the opening 32 of the fixing element 30. In the figure, the positioning portion 53 is substantially in a T-shape corresponding to the shape of the opening 32.

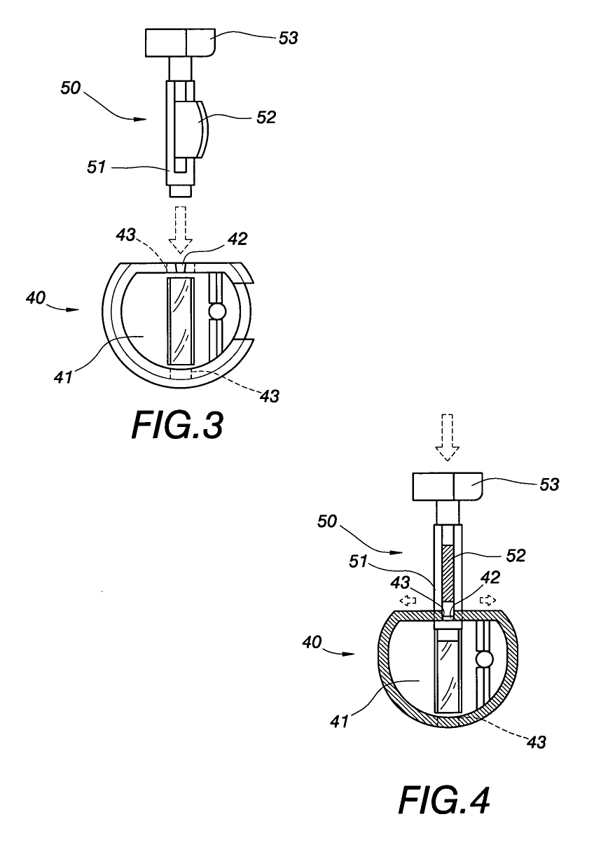

In FIGS. 3 to 5, the positioning base 40 is preferably made of a plastic material and integrally formed to facilitate assembling the turning element 50 onto the positioning base 40, and the cut groove 42 is in an inwardly tapered shape with a minimum width slightly smaller than or equal to the thickness of the turning plate 52.

If the rod 51 of the turning element 50 is aligned with the axle hole 43, and the turning plate 52 is aligned with the cut groove 42 to embed the turning plate 52 from the maximum external side of the cut groove 42, the sidewall of the positioning base 40 can be spread and expanded slightly and embedded into the movable groove 41 after the turning plate 52 enters into the position with the minimum width of the cut groove 42, since the positioning base 40 is made of an elastic plastic material. In the meantime, the positioning base 40 resumes its original shape after the rod 51 of the turning element 50 is embedded into the axle hole 43. Now, the thickness of the turning plate 52 is greater than or equal to the minimum width of the cut groove 42, and thus the turning plate 52 cannot be taken out easily, so as to prevent the turning element 50 from being loosened and separated from the positioning base 40.

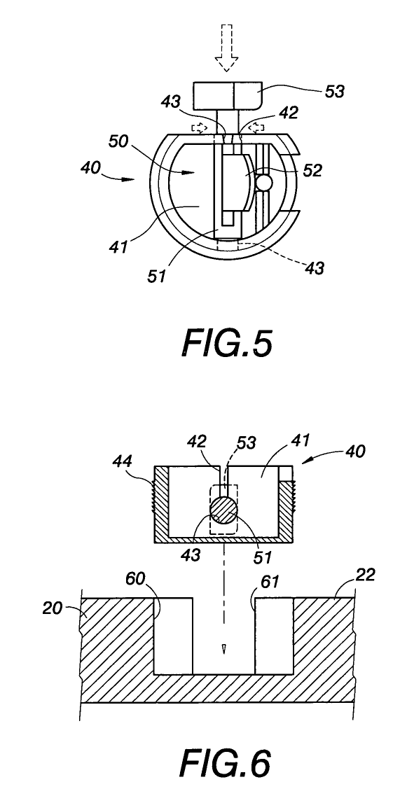

In FIGS. 5 and 6, the process of connecting the turning element 50 with the positioning base 40 requires a slight expansion or deformation of the positioning base 40, and thus the installation sequence preferably embeds the positioning base 40 into the assembling hole 60 on the vertical plane 22 of the second plate 20 after the turning element 50 is connected with the positioning base 40. During use, the external edge of the positioning base 40 can include a latch portion 44 comprised of a plurality of serrations, such that when the positioning base 40 is embedded into the assembling hole 60 on the vertical plane 22 of the second plate 20, the internal periphery of the assembling hole 60 constitutes a latch action to prevent the positioning base 40 from being loosened and separated from the assembling hole 60.

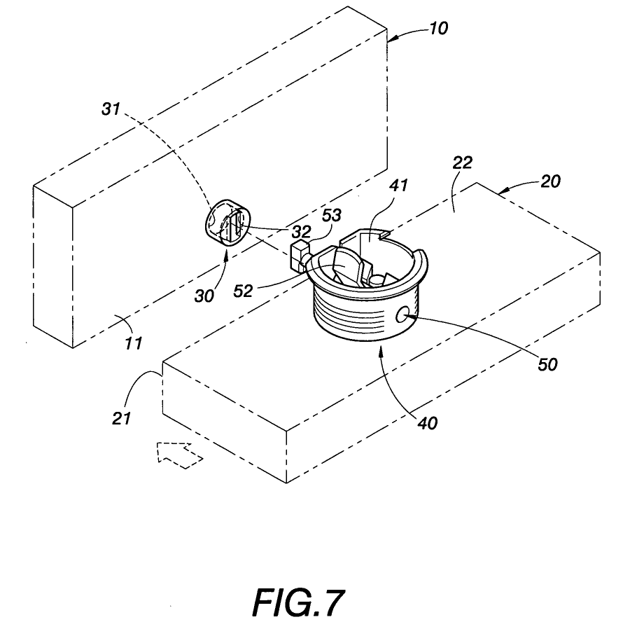

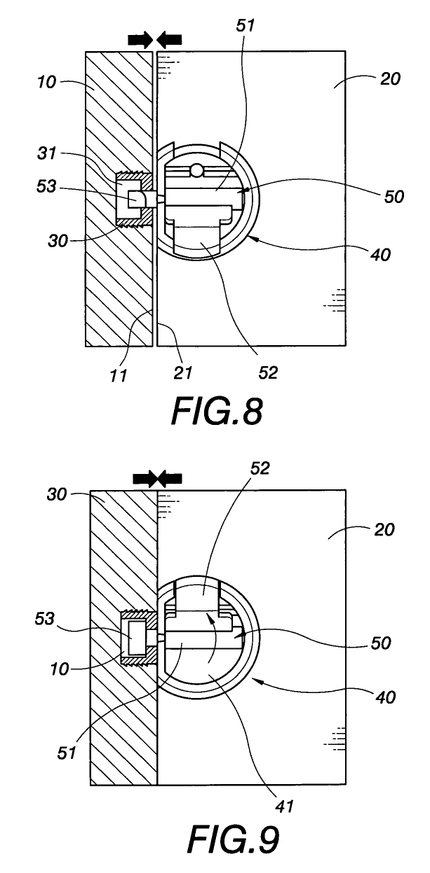

In FIGS. 7 to 9, the positioning portion 53 of the turning element 50 exposed from the joint surface 21 of the second plate 20 can be embedded into the containing space 31 from the opening 32 of the fixing element 30, after the fixing element 30 is embedded into the first plate 10, and the turning element 50 is installed at the positioning base 40, and the positioning base 40 is embedded into the second plate 20, and the joint surface 11 of the first plate 10 and the joint surface 21 of the second plate 20 are engaged. Now, the turning plate 51 is turned to drive the rod 52 to turn the positioning portion 53, so that the positioning portion 53 can be turned with respect to the opening 32 and latched into the containing space 31 to achieve a secured connection between the first plate 10 and the second plate 20.

In the figure, the positioning portion 53 is substantially in a T-shape corresponding to the shape of the opening 32, and the length of the positioning portion 53 protruded from the joint surface 21 of the second plate 20 is slightly smaller than the depth of the opening 32, so that when the rod 52 is driven to turn the positioning portion 53, the circular rod shaped positioning portion 53 provides a pressing action to press the first plate 10 and the second plate 20 with each other.

While the invention has been described by means of specific embodiments, numerous modifications and variations could be made by those skilled in the art without departing from the scope and spirit of the invention set forth in the claims.

1.-3. (canceled)

4. The latch module of claim 6, wherein the opening is substantially in a bar-shape, and the positioning portion is substantially in a T-shape corresponding to the shape of the opening, and the length of the positioning portion protruded from the joint surface of the second plate is slightly smaller than the depth of the opening.

5. The latch module of claim 6, wherein the positioning base includes a latch portion disposed on an external side of the positioning base and comprised of a plurality of serrations.

6. A latch module, installed at a joint position between a first plate and a second plate, comprising:
a fixing element embedded into a joint surface of the first plate and including a containing space formed therein, a top of the containing space having an opening, a top of the opening being exposed along the joint surface of the first plate;
a positioning base embedded into a vertical plane on a lateral edge of a joint surface of the second plate, a middle portion of the positioning base being a groove, a bottom portion of the positioning base having a transverse axle hole formed therein with an end exposed along the joint surface of the second plate; and
a turning element pivotally coupled to the transverse axle hole of the positioning base and having a rod with a diameter equal to a diameter of the transverse axle hole, the rod having a turning plate for effecting a pivoting motion to the turning element, wherein a lateral end portion of the rod is passed through the transverse axle hole and is exposed from the joint surface of the second plate, and a positioning portion is disposed on the lateral end portion corresponding to the opening of the fixing element;
wherein when the joint surface of the first plate and the joint surface of the second plate are engaged, the positioning portion of the turning element is embedded into the opening of the fixing element, the turning plate is driven to rotate the rod, and the positioning portion is rotated with respect to the opening to latch into the containing space of the fixing element to connect the first plate and the second plate,
wherein the positioning base includes a longitudinal cut groove formed in a wall of the positioning base, the longitudinal cut groove being disposed proximate to a sidewall of the joint surface of the second plate and having a width smaller than the diameter of the transverse axle hole and slightly less than or equal to a thickness of the turning plate, the positioning base being integrally formed and made of a plastic material, the cut groove of the positioning base tapering inwardly from an outer surface of the wall of the positioning base to an inner surface of the wall of the positioning base.
